(19) United States
(12) Patent Application Publication
(10) Pub. No.: US 2021/0247348 A1
(43) Pub. Date: Aug. 12, 2021

(54) BIOSENSORS COATED WITH CO-POLYMERS AND THEIR USES THEREOF

(71) Applicant: MICRO TECH MEDICAL (HANGZHOU) CO.,LTD., Hangzhou (CN)

(72) Inventor: Fei YU, Hangzhou (CN)

(73) Assignee: MICROTECH MEDICAL (HANGZHOU) CO.,LTD., Hangzhou (CN)

(21) Appl. No.: 16/638,856

(22) PCT Filed: Apr. 30, 2019
(86) PCT No.: PCT/CN2019/085198

§ 371 Date: Feb. 13, 2020

(51) Int. Cl. G01N 27/327; G01N 27/30; C08G 18/40; C08G 18/44; C08G 18/50; C08G 18/61; C08G 18/62

(52) U.S. Cl. CPC G01N 27/3278; G01N 27/301; C08G 18/4018; B82Y 30/00; C08G 18/5024; C08G 18/61; C08G 18/6229; C08G 18/44

(57) ABSTRACT

Biosensors coated with co-polymers and their uses thereof includes a substrate; a working electrode on top of the substrate; a detection layer on a top of the working electrode, wherein the detection layer comprises a metallic nanoparticle, polydopamine, and a peptide probe; a biocompatible membrane on a top of the detection layer, wherein the biocompatible membrane comprises a triblock polymer A-b-B-b-C, wherein: A is a hydrophilic soft segment, B is a hydrophobic hard segment, C is a flexible polymer segment, and b is a chain extender.

### CROSS REFERENCES TO THE RELATED APPLICATIONS

This application is the national phase entry of International Application No. PCT/CN2019/085198, filed on Apr. 30, 2019, the entire contents of which are incorporated herein by reference.

### TECHNICAL FIELD

The present invention relates to biosensors coated with co-polymers and their uses thereof. Methods of preparing the biosensors are also provided.

### BACKGROUND

Electrochemical biosensors that employ biological recognition systems and electrochemical transudation offer a possibility of quick and real-time analysis, which is particularly suited for the rapid measurement of point-of-care industry. The outer membrane of a biosensor is very important, as it represents the interface between the sensor and the analyte medium. The purpose of this interface membrane is to allow the diffusion of analytes into the detection layer while excluding potential interfering species which may be present in the analyte medium. Therefore, there is a need for biosensors with improved interface membranes.

### SUMMARY

In one aspect, provided is a biosensor, comprising: a substrate; a working electrode one top of the substrate; a detection layer one top of the working electrode, wherein the detection layer comprises a metallic nanoparticle, polydopamine, and a peptide probe; a biocompatible membrane one top of the detection layer, wherein the biocompatible membrane comprises a triblock polymer A-b-B-b-C, wherein: A is a hydrophilic soft segment, B is a hydrophobic hard segment, C is a flexible polymer segment, and b is a chain extender.

In some embodiments according to the embodiments above, the working electrode comprises carbon, graphene, gold, or platinum.

In some embodiments according to any of the embodiments above, the metallic nanoparticle is a platinum nanoparticle, a gold nanoparticle, or an iridium nanoparticle.

In some embodiments according to any of the embodiments above, the metallic nanoparticle has a dimension of between about 1 and about 100 nanometers.

In some embodiments according to any of the embodiments above, the peptide probe comprises an enzyme, an antibody, or a polymer comprising a peptide.

In some embodiments according to any of the embodiments above, the peptide probe comprises an oxidoreductase.

In some embodiments according to any of the embodiments above, the peptide probe comprises glucose oxidase, glucose dehydrogenase, or horseradish peroxidase.

In some embodiments according to any of the embodiments above, the metallic nanoparticle is coated with polydopamine and the peptide probe. In some embodiments according to any of the embodiments above, the metallic nanoparticle is admixed with polydopamine and the peptide probe.

In some embodiments according to any of the embodiments above, the hydrophilic soft segment comprises a polymer selected from the group consisting of polyethylene glycol (PEG), polypropylene glycol (PPG), and polyetheramine (PEA).

In some embodiments according to any of the embodiments above, the hydrophobic hard segment comprises a polymer selected from the group consisting of polycarbonate (PC) and poly(methyl methacrylate) (PMMA).

In some embodiments according to any of the embodiments above, the flexible polymer segment comprises a polymer selected from the group consisting of polydimethylsiloxane (PDMS) and poly(2-hydroxyethyl methacrylate) (PHEMA).

In some embodiments according to any of the embodiments above, the chain extender in the biocompatible membrane is derived from a compound comprising an isocyanate.

In some embodiments according to any of the embodiments above, wherein each chain extender is independently derived from methylene diphenyl diisocyanate (MDI), hexamethylene diisocyanate (HDI), or bis(4-isocyanatocyclohexyl)methane.

In some embodiments according to any of the embodiments above, the number average molecular weight of A is between about 200 and about 10000, the number average molecular weight of B is between about 1000 and about 20000, and the number average molecular weight of C is between about 1000 and about 20000.

In some embodiments according to any of the embodiments above, the biocompatible membrane comprises: between about 1 and about 10 parts by weight of A, between about 1 and about 5 parts by weight of B, between about 1 and about 5 parts by weight of C, and between about 1 and about 3 parts by weight of b.

In some embodiments according to any of the embodiments above, the linkage between each of A-b, B-b, and C-b is independently a urea linkage or a carbamate linkage.

In some embodiments according to any of the embodiments above, the biosensor further comprises an adhesive layer between the detection layer and the biocompatible membrane, wherein the adhesive layer comprises a polymer comprising a first monomer comprising at least two amine moieties crosslinked with a second monomer comprising at least two formyl moieties.

In some embodiments according to any of the embodiments above, the first monomer is 1,6-diaminohexane and the second monomer is glutaraldehyde.

In some embodiments according to any of the embodiments above, the biosensor further comprises a blank electrode which is substantially same as the working electrode, a counter electrode, and a reference electrode, wherein the blank electrode is directly covered by the biocompatible membrane. In some embodiments, the blank electrode is directly covered by the adhesive layer, which is covered by the biocompatible membrane.

In some embodiments according to any of the embodiments above, the minimum distance between the working electrode and the blank electrode is no more than about 5 mm.

In another aspect, provided is a method of preparing a biosensor according to any of the embodiments above, comprising: (1) forming a working electrode on a substrate; (2) forming a detection layer one top of the working electrode, wherein the detection layer comprises a metallic nanoparticle, polydopamine, and a peptide probe; (3) forming a triblock polymer A-b-B-b-C one top of the detection layer, wherein: A is a hydrophilic soft segment, B is a hydrophobic hard segment, C is a flexible polymer segment, and b is a chain extender.

In some embodiments of preparing a biosensor according to any of the embodiment above, the working electrode comprises carbon, graphene, gold, or platinum.

In some embodiments of preparing a biosensor according to any of the embodiments above, step (1) comprises forming the working electrode one top of the substrate by etching or screen printing.

In some embodiments of preparing a biosensor according to any of the embodiments above, the metallic nanoparticle is a platinum nanoparticle, a gold nanoparticle, or an iridium nanoparticle.

In some embodiments of preparing a biosensor according to any of the embodiments above, the metallic nanoparticle has a dimension of between about 1 and about 100 nanometers.

In some embodiments of preparing a biosensor according to any of the embodiments above, the peptide probe comprises an enzyme, an antibody, or a polymer comprising a peptide.

In some embodiments of preparing a biosensor according to any of the embodiments above, the peptide probe comprises an oxidoreductase.

In some embodiments of preparing a biosensor according to any of the embodiments above, the peptide probe comprises glucose oxidase, glucose dehydrogenase, or horseradish peroxidase.

In some embodiments of preparing a biosensor according to any of the embodiments above, the hydrophilic soft segment comprises a polymer selected from the group consisting of polyethylene glycol (PEG), polypropylene glycol (PPG), and polyetheramine (PEA).

In some embodiments of preparing a biosensor according to any of the embodiments above, the hydrophobic hard segment comprises a polymer selected from the group consisting of polycarbonate (PC) and poly(methyl methacrylate) (PMMA).

In some embodiments of preparing a biosensor according to any of the embodiments above, the flexible polymer segment comprises a polymer selected from the group consisting of polydimethylsiloxane (PDMS) and poly(2-hydroxyethyl methacrylate) (PHEMA).

In some embodiments of preparing a biosensor according to any of the embodiments above, the chain extender in the biocompatible membrane is derived from a compound comprising an isocyanate.

In some embodiments of preparing a biosensor according to any of the embodiments above, each chain extender is independently derived from methylene diphenyl diisocyanate (MDI), hexamethylene diisocyanate (HDI), or bis(4-isocyanatocyclohexyl)methane.

In some embodiments of preparing a biosensor according to any of the embodiments above, the number average molecular weight of A is between about 200 and about 10000, the number average molecular weight of B is between about 1000 and about 20000, and the number average molecular weight of C is between about 1000 and about 20000.

In some embodiments of preparing a biosensor according to any of the embodiments above, the biocompatible membrane comprises: between about 1 and about 10 parts by weight of A, between about 1 and about 5 parts by weight of B, between about 1 and about 5 parts by weight of C, and between about 1 and about 3 parts by weight of b.

In some embodiments of preparing a biosensor according to any of the embodiments above, the linkage between each of A-b, B-b, and C-b is independently a urea linkage or a carbamate linkage.

In some embodiments of preparing a biosensor according to any of the embodiments above, step (2) comprises: (a) mixing the peptide probe, dopamine or a derivative thereof, and a metallate in water, thereby forming a solution comprising a metallic nanoparticle with a coating comprising polydopamine and the peptide probe, wherein the metallate is an oxidizing agent; and (b) depositing the metallic nanoparticle with a coating comprising polydopamine and the peptide probe one top of the working electrode by an electrochemical oxidation reaction.

In some embodiments of preparing a biosensor according to any of the embodiments above, (i) the concentration of the peptide probe in the solution is between about 0.1 and about 10 mg/mL; (ii) the concentration of dopamine or a derivative thereof in the solution is between about 1 and about 10 g/L; (iii) the metallate comprises chloroplatinic acid, chloroauric acid, or chloroacridin acid, wherein the concentration of the metallate is between about 0.1 and about 1 mg/L; (iv) the pH of the solution is between about 7 and about 9; (v) the dissolved oxygen concentration saturation in the solution is less than about 1%; (vi) the temperature is between about 20 and about 40° C.; and/or (vii) the potential applied to the working electrode relative to a silver/silver chloride reference solution electrode is between about 0 and about 0.8 V.

In some embodiments of preparing a biosensor according to any of the embodiments above, step (2) comprises: (a) mixing a metallic nanoparticle, a peptide probe, and dopamine or a derivative thereof in water; (b) contacting the working electrode with the solution formed in step (a); and (c) forming the detection layer one top of the working electrode by an electrochemical oxidation reaction.

In some embodiments of preparing a biosensor according to any of the embodiments above, (i) the metallic nanoparticle has a dimension of between about 1 and about 100 nanometers; (ii) the concentration of the metallic nanoparticle is between about 1000 and about 5000 ppm; (iii) the concentration of the peptide probe in the solution is between 0.1 and about 10 mg/mL; (iv) the concentration of dopamine or a derivative thereof in the solution is between about 1 and about 10 g/L; (v) the pH of the solution is between about 7 and about 9; (vi) the dissolved oxygen concentration saturation in the solution is less than about 1%; (vii) the temperature is between about 20 and about 40° C.; and/or (viii) the potential applied to the working electrode relative to a silver/silver chloride reference solution electrode is between about −0.5 and about 0.8 V.

In some embodiments of preparing a biosensor according to any of the embodiments above, dopamine is used in step (2).

In some embodiments of preparing a biosensor according to any of the embodiments above, a derivative of dopamine is used in step (2), wherein the derivative of dopamine is formed by oxidizing dopamine or reducing dopamine.

In some embodiments of preparing a biosensor according to any of the embodiments above, the derivative of dopamine is levodopa or dihydroxyindole.

In some embodiments of preparing a biosensor according to any of the embodiments above, step (3) comprises: (a) mixing A, B, and C in an organic solvent at a temperature of between about 30 and about 45° C.; (b) adding a catalyst to the solution formed in step (a) and adding a compound comprising an isocyanate dropwise, increasing the temperature of the solution to between about 55 and about 70° C., and allowing the solution to react for between about 12 and about 20 hours at the temperature; and (c) adding deionized water to the solution formed in step (b) and allowing the resulting mixture to react for between about 12 and about 18 hours.

In some embodiments of preparing a biosensor according to any of the embodiments above, (i) the organic solvent is tetrahydrofuran (THF), Cyclohexanone, isobutanol or a mixture thereof; and (ii) the ratio of the volume of the organic solvent to the total mass of A, B, and C is between about 2 and about 10 mL:1 g.

In some embodiments of preparing a biosensor according to any of the embodiments above, the catalyst comprises triethylenediamine or dibutyltin bis(2-ethylhexanoate).

In some embodiments of preparing a biosensor according to any of the embodiments above, the ratio of the volume of the deionized water added in step (c) to the total mass of A, B, and C is between about 1 and about 10 mL:1 g.

In some embodiments of preparing a biosensor according to any of the embodiments above, step (3) comprises forming an adhesive layer on top of the detection layer and forming the triblock polymer on top of the adhesive layer, wherein the adhesive layer comprises a polymer comprising a first monomer comprising at least two amine moieties crosslinked with a second monomer comprising at least two formyl moieties.

In some embodiments of preparing a biosensor according to any of the embodiments above, the first monomer is 1,6-diaminohexane and the second monomer is glutaraldehyde.

In some embodiments of preparing a biosensor according to any of the embodiments above, the process of cross-linking the first monomer and second monomer comprises: (i) applying the first monomer to the detection layer in ethanol, and (2) applying the second monomer to the detection layer in a gaseous phase at a temperature of between about 40 and about 55° C.

In another aspect, a method of using the biosensor described herein is provided. In some embodiments, the biosensor described herein is suitable for use in a system for assessing an analyte in a sample fluid. In some embodiments, the system may provide methods for evaluating the sample fluid for the target analyte. The evaluation may range from detecting the presence of the analyte to determining the concentration of the analyte. The analyte and the sample fluid may be any for which the test system is appropriate. In some embodiments, the analyte is glucose and the sample fluid is blood or interstitial fluid.

### BRIEF DESCRIPTION OF THE DRAWINGS

FIG. 1 shows an exemplary process of forming the detection layer on top of the working electrode.

FIG. 2 shows another exemplary process of forming the detection layer on top of the working electrode.

FIG. 3 shows current outputs over time at different glucose concentrations for different biosensors.

### DETAILED DESCRIPTION OF THE EMBODIMENTS

### Definitions

Unless defined otherwise, all technical and scientific terms used herein have the same meaning as is commonly understood by one of ordinary skill in the art to which this invention belongs. All patents, applications, published applications, other publications and databases referred to herein are incorporated by reference in their entirety. If a definition set forth in this section is contrary to or otherwise inconsistent with a definition set forth in applications, published applications and other publications that are herein incorporated by reference, the definition set forth in this section prevails over the definition that is incorporated herein by reference.

As used herein, and unless otherwise specified, the terms “about” and “approximately,” when used in connection with doses, amounts, or weight percent of ingredients of a composition or a dosage form, mean a dose, amount, or weight percent that is recognized by those of ordinary skill in the art to provide a pharmacological effect equivalent to that obtained from the specified dose, amount, or weight percent. Specifically, the terms “about” and “approximately,” when used in this context, contemplate a dose, amount, or weight percent within 15%, within 10%, within 5%, within 4%, within 3%, within 2%, within 1%, or within 0.5% of the specified dose, amount, or weight percent.

As used herein, “a” or “an” means “at least one” or “one or more.”’

As used herein, the terms “including,” “containing,” and “comprising” are used in their open, non-limiting sense.

For clarity of disclosure, and not by way of limitation, the detailed description of the invention is divided into the subsections that follow.

### Biosensors

In one aspect, provided is a biosensor, comprising: a substrate; a working electrode on top of the substrate; a detection layer on top of the working electrode, wherein the detection layer comprises a metallic nanoparticle, polydopamine, and a peptide probe; a biocompatible membrane on top of the detection layer, wherein the biocompatible membrane comprises a triblock polymer A-b-B-b-C, wherein: A is a hydrophilic soft segment, B is a hydrophobic hard segment, C is a flexible polymer segment, and b is a chain extender.

i. Substrate

Examples of substrate materials include, but are not limited to, inorganic materials such as glass and silicon wafer, and organic materials such as polyimide and polydimethylsiloxane. In some embodiments, the substrate comprises glass. In some embodiments, the substrate comprises silicon wafer. In some embodiments, the substrate comprises polyimide. In some embodiments, the substrate comprises polydimethylsiloxane.

ii. Working Electrode

In some embodiments, the working electrode may be prepared using any suitable conductive materials. In some embodiments, the working electrode comprises carbon, graphene, gold, or platinum. In some embodiments, the working electrode comprises carbon. In some embodiments, the working electrode comprises graphene. In some embodiments, the working electrode comprises gold. In some embodiments, the working electrode comprises platinum.

iii. Detection Layer

In some embodiments, the detection layer comprises a metallic nanoparticle, polydopamine, and a peptide probe. In some embodiments, the term “nanoparticle” refers to a nanoscale particle with a size that is measured in nanometers. In some embodiments, the metallic nanoparticle is a platinum nanoparticle, a gold nanoparticle, or an iridium nanoparticle. In some embodiments, the metallic nanoparticle is a platinum nanoparticle. In some embodiments, the metallic nanoparticle is a gold nanoparticle. In some embodiments, the metallic nanoparticle is an iridium nanoparticle.

In some embodiments, the metallic nanoparticle has a dimension of between about 1 and about 900, between about 1 and about 800, between about 1 and about 700, between about 1 and about 600, between about 1 and about 500, between about 1 and about 400, between about 1 and about 300, between about 1 and about 200, between about 1 and about 100, between about 1 and about 50, between about 50 and about 900, between about 50 and about 800, between about 50 and about 700, between about 50 and about 600, between about 50 and about 500, between about 50 and about 400, between about 50 and about 300, between about 50 and about 200, between about 50 and about 100, between about 100 and about 900, between about 200 and about 800, between about 200 and about 700, between about 200 and about 600, between about 200 and about 500, between about 200 and about 400, between about 200 and about 300, 300 and about 900, between about 300 and about 800, between about 300 and about 700, between about 300 and about 600, between about 300 and about 500, between about 300 and about 400, 400 and about 900, between about 400 and about 800, between about 400 and about 700, between about 400 and about 600, between about 400 and about 500, between about 500 and about 900, between about 500 and about 800, between about 500 and about 700, between about 500 and about 600, between about 600 and about 900, between about 600 and about 800, between about 600 and about 700, between about 700 and about 900, between about 700 and about 800, between about 800 and about 900, between about 1 and about 90, between about 1 and about 80, between about 1 and about 70, between about 1 and about 60, between about 1 and about 50, between about 1 and about 40, between about 1 and about 30, between about 1 and about 20, or between about 1 and about 10 nanometers. In some embodiments, the metallic nanoparticle has a dimension of less than about 900, about 800, about 700, about 600, about 500, about 400, about 300, about 200, about 100, about 90, about 80, about 70, about 60, about 50, about 40, about 30, about 20, or about 10 nanometers. In some embodiments, the metallic nanoparticle has a dimension of at least about 900, about 800, about 700, about 600, about 500, about 400, about 300, about 200, about 100, about 90, about 80, about 70, about 60, about 50, about 40, about 30, about 20, about 10, or about 1 nanometers. In some embodiments, the metallic nanoparticle has a dimension of about 900, about 800, about 700, about 600, about 500, about 400, about 300, about 200, about 100, about 90, about 80, about 70, about 60, about 50, about 40, about 30, about 20, about 10, or about 1 nanometers. In some embodiments, the metallic nanoparticle has a dimension of between about 1 and about 100 nanometers.

In some embodiments, the peptide probe comprises an enzyme, an antibody, or a polymer comprising a peptide. In some embodiments, the peptide probe comprises an enzyme. In some embodiments, the peptide probe comprises an oxidoreductase. In some embodiments, the peptide probe comprises an oxidase such as glucose oxidase, glutamate oxidase, alcohol oxidase, lactate oxidase, ascorbate oxidase, cholesterol oxidase, or choline oxidase. In some embodiments, the peptide probe comprises a dehydrogenase such as alcohol dehydrogenase, glutamate dehydrogenase, glucose dehydrogenase, or lactate dehydrogenase. In some embodiments, the peptide probe comprises a peroxidase such as horseradish peroxidase. In some embodiments, the peptide probe comprises glucose oxidase, glutamate oxidase, alcohol oxidase, lactate oxidase, ascorbate oxidase, cholesterol oxidase, choline oxidase, alcohol dehydrogenase, glutamate dehydrogenase, glucose dehydrogenase, lactate dehydrogenase, or horseradish peroxidase. In some embodiments, the peptide probe comprises glucose oxidase, glucose dehydrogenase, or horseradish peroxidase. In some embodiments, the peptide probe comprises an antibody such as hepatitis B antibody. In some embodiments, the peptide probe comprises a polymer comprising a peptide.

In some embodiments, the metallic nanoparticle is coated with polydopamine and the peptide probe. In some embodiments, the metallic nanoparticle is admixed with polydopamine and the peptide probe.

iv. Biocompatible Membrane

In some embodiments, the biocompatible membrane comprises a triblock polymer A-b-B-b-C, wherein A is a hydrophilic soft segment. In some embodiments, the hydrophilic soft segment comprises a polymer selected from the group consisting of polyethylene glycol (PEG), polypropylene glycol (PPG), and polyetheramine (PEA). In some embodiments, the hydrophilic soft segment comprises PEG. In some embodiments, the hydrophilic soft segment comprises PPG. In some embodiments, the hydrophilic soft segment comprises PEA. In some embodiments, the hydrophilic soft segment comprises at least two polymers selected from the group consisting of PEG, PPG, and PEA. In some embodiments, the hydrophilic soft segment comprises PEG, PPG, and PEA.

In some embodiments, the biocompatible membrane comprises a triblock polymer A-b-B-b-C, wherein B is a hydrophobic hard segment. In some embodiments, the hydrophobic hard segment comprises a polymer selected from the group consisting of polycarbonate (PC) and poly(methyl methacrylate) (PMMA). In some embodiments, the hydrophobic hard segment comprises PC. In some embodiments, the hydrophobic hard segment comprises PMMA. In some embodiments, the hydrophobic hard segment comprises PC and PMMA.

In some embodiments, the biocompatible membrane comprises a triblock polymer A-b-B-b-C, wherein C is a flexible polymer segment. In some embodiments, the flexible polymer segment comprises a polymer selected from the group consisting of polydimethylsiloxane (PDMS) and poly(2-hydroxyethyl methacrylate) (PHEMA). In some embodiments, the flexible polymer segment comprises PDMS. In some embodiments, the flexible polymer segment comprises PHEMA. In some embodiments, the flexible polymer segment comprises PDMS and PHEMA.

In some embodiments, the biocompatible membrane comprises a triblock polymer A-b-B-b-C, wherein b is a chain extender. In some embodiments, the chain extender in the biocompatible membrane is derived from a compound comprising an isocyanate (i.e., a —NCO group). In some embodiments wherein each chain extender is independently derived from methylene diphenyl diisocyanate (MDI), hexamethylene diisocyanate (HDI), or bis(4-isocyanatocyclohexyl)methane. In some embodiments, the chain extender is MDI. In some embodiments, the chain extender is HDI. In some embodiments, the chain extender is bis(4-isocyanatocyclohexyl)methane.

In some embodiments, the molecular weight of each of A, B, and C is determined by measuring the molecular mass of n polymer molecules, summing the masses, and dividing the total mass by n (i.e., number average molecular weight). In some embodiments, the number average molecular weight of A is between about 100 and about 10000, between about 200 and about 10000, between about 500 and about 10000, between about 1000 and about 10000, between about 2000 and about 10000, or between about 5000 and between about 10000. In some embodiments, the number average molecular weight of A is at least about 100, about 200, about 300, about 400, about 500, about 600, about 700, about 800, about 900, about 1000, about 2000, about 3000, about 4000, about 5000, about 6000, about 7000, about 8000, about 9000, about 10000, about 15000, or about 20000. In some embodiments, the number average molecular weight of A is less than about 100, about 200, about 300, about 400, about 500, about 600, about 700, about 800, about 900, about 1000, about 2000, about 3000, about 4000, about 5000, about 6000, about 7000, about 8000, about 9000, about 10000, about 15000, or about 20000. In some embodiments, the number average molecular weight of A is about 100, about 200, about 300, about 400, about 500, about 600, about 700, about 800, about 900, about 1000, about 2000, about 3000, about 4000, about 5000, about 6000, about 7000, about 8000, about 9000, about 10000, about 15000, or about 20000. In some embodiments, the number average molecular weight of A is between about 200 and about 10000.

In some embodiments, the number average molecular weight of B is between about 100 and about 20000, between about 200 and about 20000, between about 500 and about 20000, between about 1000 and about 20000, between about 2000 and about 20000, or between about 5000 and between about 20000. In some embodiments, the number average molecular weight of B is at least about 100, about 200, about 300, about 400, about 500, about 600, about 700, about 800, about 900, about 1000, about 2000, about 3000, about 4000, about 5000, about 6000, about 7000, about 8000, about 9000, about 10000, about 15000, or about 20000. In some embodiments, the number average molecular weight of B is less than about 100, about 200, about 300, about 400, about 500, about 600, about 700, about 800, about 900, about 1000, about 2000, about 3000, about 4000, about 5000, about 6000, about 7000, about 8000, about 9000, about 10000, about 15000, or about 20000. In some embodiments, the number average molecular weight of B is about 100, about 200, about 300, about 400, about 500, about 600, about 700, about 800, about 900, about 1000, about 2000, about 3000, about 4000, about 5000, about 6000, about 7000, about 8000, about 9000, about 10000, about 11000, about 12000, about 13000, about 14000, about 15000, about 16000, about 17000, about 18000, about 19000, or about 20000. In some embodiments, the number average molecular weight of B is between about 1000 and about 20000.

In some embodiments, the number average molecular weight of C is between about 100 and about 20000, between about 200 and about 20000, between about 500 and about 20000, between about 1000 and about 20000, between about 2000 and about 20000, or between about 5000 and between about 20000. In some embodiments, the number average molecular weight of C is at least about 100, about 200, about 300, about 400, about 500, about 600, about 700, about 800, about 900, about 1000, about 2000, about 3000, about 4000, about 5000, about 6000, about 7000, about 8000, about 9000, about 10000, about 15000, or about 20000. In some embodiments, the number average molecular weight of C is less than about 100, about 200, about 300, about 400, about 500, about 600, about 700, about 800, about 900, about 1000, about 2000, about 3000, about 4000, about 5000, about 6000, about 7000, about 8000, about 9000, about 10000, about 15000, or about 20000. In some embodiments, the number average molecular weight of C is about 100, about 200, about 300, about 400, about 500, about 600, about 700, about 800, about 900, about 1000, about 2000, about 3000, about 4000, about 5000, about 6000, about 7000, about 8000, about 9000, about 10000, about 11000, about 12000, about 13000, about 14000, about 15000, about 16000, about 17000, about 18000, about 19000, or about 20000. In some embodiments, the number average molecular weight of C is between about 1000 and about 20000.

In some embodiments according to any of the embodiments above, the biocompatible membrane comprises: between about 1 and about 10 parts by weight of A, between about 1 and about 5 parts by weight of B, between about 1 and about 5 parts by weight of C, and between about 1 and about 3 parts by weight of b.

In some embodiments according to any of the embodiments above, the linkage between each of A-b, B-b, and C-b is independently a urea linkage or a carbamate linkage. In some embodiment, the linkage between A-b is a urea linkage. In some embodiment, the linkage between A-b is a carbamate linkage. In some embodiment, the linkage between B-b is a urea linkage. In some embodiment, the linkage between B-b is a carbamate linkage. In some embodiment, the linkage between C-b is a urea linkage. In some embodiment, the linkage between C-b is a carbamate linkage.

v. Adhesive Layer

In some embodiments according to any of the embodiments above, the biosensor further comprises an adhesive layer positioned between the detection layer and the biocompatible membrane, wherein the adhesive layer comprises a polymer comprising a first monomer comprising at least two amine moieties crosslinked with a second monomer comprising at least two formyl moieties.

In some embodiments, the first monomer comprises at least two, three, four, or five amine moieties. In some embodiments, the first monomer comprises two amine moieties. In some embodiments, the first monomer has the structure H₂N-alkylene-NH₂. “Alkylene” refers to divalent aliphatic hydrocarbyl groups preferably having from 1 to 8 carbon atoms that are either straight-chained or branched. Examples of alkylene include, but are not limited to, methylene (—CH₂—), ethylene (—CH₂CH₂—), n-propylene (—CH₂CH₂CH₂—), iso-propylene (—CH₂CH(CH₃)—), —C(CH₃)₂CH₂CH₂—, —C(CH₃)₂CH₂— and the like. In some embodiments, the first monomer is 1,6-diaminohexane.

In some embodiments, the second monomer comprises at least two, three, four, or five formyl moieties. In some embodiments, the second monomer comprises two formyl moieties. In some embodiments, the second monomer is glyoxal, malondialdehyde, succindialdehyde, glutaraldehyde, or phthalaldehyde. In some embodiments, the second monomer is glutaraldehyde.

In some embodiments according to any of the embodiments above, the biosensor further comprises a blank electrode which is substantially same as the working electrode, a counter electrode, and a reference electrode, wherein the blank electrode is directly covered by the biocompatible membrane or directly covered by the adhesive layer, which is covered by the biocompatible membrane. In some embodiments, the working and blank electrodes are comprised of substantially identical material(s), i.e., identical or nearly identical materials are used in both working and blank electrodes, and of substantially some size so that both electrodes have identical or nearly identical electron transfer properties. In some embodiments, the difference of the electron transfer properties between the two electrodes is less than 10%, 9%, 8%, 7%, 6%, 5%, 4%, 3%, 2%, 1%, or 0.5%. In some embodiments, the working and blank electrodes are made of identical material(s) and there is no difference in their electron transfer properties. In some embodiments, the working and counter electrodes are comprised of substantially identical material(s), i.e., identical or nearly identical materials are used in both working and counter electrodes so that both electrodes have identical or nearly identical electron transfer properties. In some embodiments, the difference of the electron transfer properties between the two electrodes is less than 10%, 9%, 8%, 7%, 6%, 5%, 4%, 3%, 2%, 1%, or 0.5%. In some embodiments, the working and counter electrodes are made of identical material(s) and there is no difference in their electron transfer properties.

In some embodiments, the minimum distance between the working electrode and the blank electrode is no more than about 1 mm, about 2 mm, about 3 mm, about 4 mm, about 5 mm, about 6 mm, about 7 mm, about 8 mm, about 9 mm, or about 10 mm. In some embodiments, the minimum distance between the working electrode and the blank electrode is less than about 1 mm, about 2 mm, about 3 mm, about 4 mm, about 5 mm, about 6 mm, about 7 mm, about 8 mm, about 9 mm, or about 10 mm. In some embodiments, the minimum distance between the working electrode and the blank electrode is about 1 mm, about 2 mm, about 3 mm, about 4 mm, about 5 mm, about 6 mm, about 7 mm, about 8 mm, about 9 mm, or about 10 mm. In some embodiments, the minimum distance between the working electrode and the blank electrode is no more than about 5 mm.

### Methods of Preparation

In another aspect, provided is a method of preparing a biosensor according to any of the embodiments above, comprising: (1) forming a working electrode on a substrate; (2) forming a detection layer on top of the working electrode, wherein the detection layer comprises a metallic nanoparticle, polydopamine, and a peptide probe; (3) forming a triblock polymer A-b-B-b-C on top of the detection layer, wherein: A is a hydrophilic soft segment, B is a hydrophobic hard segment, C is a flexible polymer segment, and b is a chain extender, wherein the working electrode, detection layer, the triblock polymer A-b-B-b-C are as detailed herein.

In some embodiments, step (1) comprises forming the working electrode on top of the substrate by etching or screen printing.

In some embodiments, step (2) comprises: (a) mixing the peptide probe, dopamine or a derivative thereof, and a metallate in water, thereby forming a solution comprising a metallic nanoparticle with a coating comprising polydopamine and the peptide probe, wherein the metallate is an oxidizing agent; and (b) depositing the metallic nanoparticle with a coating comprising polydopamine and the peptide probe on top of the working electrode by an electrochemical oxidation reaction.

In some embodiments of preparing a biosensor according to any of the embodiments above, (i) the metallic nanoparticle has a dimension of between about 1 and about 100 nanometers; (ii) the concentration of the metallic nanoparticle is between about 1000 and about 5000 ppm; (iii) the concentration of the peptide probe in the solution is between 0.1 and about 10 mg/mL; (iv) the concentration of dopamine or a derivative thereof in the solution is between about 1 and about 10 g/L; (v) the pH of the solution is between about 7 and about 9; (vi) the dissolved oxygen concentration saturation in the solution is less than about 1%; (vii) the temperature is between about 20 and about 40° C.; and/or (viii) the potential applied to the working electrode relative to a silver/silver chloride reference solution electrode is between about −0.5 and about 0.8 V.

In some embodiments of preparing a biosensor according to any of the embodiments above, the concentration of the peptide probe in the solution of step (2) is between about 0.1 and about 50, between about 0.1 and about 40, between about 0.1 and about 30, between about 0.1 and about 20, between about 0.1 and about 10, between about 0.1 and about 9, between about 0.1 and about 8, between about 0.1 and about 7, between about 0.1 and about 6, between about 0.1 and about 5, between about 0.1 and about 4, between about 0.1 and about 3, between about 0.1 and about 2, between about 0.1 and about 1, between about 0.1 and about 0.5, between about 0.5 and about 50, between about 0.5 and about 40, between about 0.5 and about 30, between about 0.5 and about 20, between about 0.5 and about 10, between about 0.5 and about 9, between about 0.5 and about 8, between about 0.5 and about 7, between about 0.5 and about 6, between about 0.5 and about 5, between about 0.5 and about 4, between about 0.5 and about 3, between about 0.5 and about 2, between about 0.5 and about 1, between about 1 and about 50, between about 1 and about 40, between about 1 and about 30, between about 1 and about 20, between about 1 and about 10, between about 1 and about 9, between about 1 and about 8, between about 1 and about 7, between about 1 and about 6, between about 1 and about 5, between about 1 and about 4, between about 1 and about 3, between about 1 and about 2, between about 5 and about 50, between about 5 and about 40, between about 5 and about 30, between about 5 and about 20, or between about 5 and about 10 mg/mL. In some embodiments, the concentration of the peptide probe in the solution of step (2) is at least about 0.01, about 0.05, about 0.1, about 0.5, about 1, about 2, about 3, about 4, about 5, about 6, about 7, about 8, about 9, or about 10 mg/mL. In some embodiments, the concentration of the peptide probe in the solution of step (2) is less than about 0.01, about 0.05, about 0.1, about 0.5, about 1, about 2, about 3, about 4, about 5, about 6, about 7, about 8, about 9, or about 10 mg/mL. In some embodiments, the concentration of the peptide probe in the solution of step (2) is about 0.01, about 0.05, about 0.1, about 0.5, about 1, about 2, about 3, about 4, about 5, about 6, about 7, about 8, about 9, or about 10 mg/mL. In some embodiments, the concentration of the peptide probe in the solution of step (2) is between about 0.1 and about 10 mg/mL.

In some embodiments of preparing a biosensor according to any of the embodiments above, the concentration of dopamine or a derivative thereof in the solution of step (2) is between about 0.5 and about 50, between about 0.5 and about 40, between about 0.5 and about 30, between about 0.5 and about 20, between about 0.5 and about 10, between about 0.5 and about 9, between about 0.5 and about 8, between about 0.5 and about 7, between about 0.5 and about 6, between about 0.5 and about 5, between about 0.5 and about 4, between about 0.5 and about 3, between about 0.5 and about 2, between about 0.5 and about 1, between about 1 and about 50, between about 1 and about 40, between about 1 and about 30, between about 1 and about 20, between about 1 and about 10, between about 1 and about 9, between about 1 and about 8, between about 1 and about 7, between about 1 and about 6, between about 1 and about 5, between about 1 and about 4, between about 1 and about 3, between about 1 and about 2, between about 5 and about 50, between about 5 and about 40, between about 5 and about 30, between about 5 and about 20, or between about 5 and about 10 g/L. In some embodiments, the concentration of dopamine or a derivative thereof in the solution of step (2) is at least about 0.01, about 0.05, about 0.1, about 0.5, about 1, about 2, about 3, about 4, about 5, about 6, about 7, about 8, about 9, or about 10 g/L. In some embodiments, the concentration of dopamine or a derivative thereof in the solution of step (2) is less than about 0.01, about 0.05, about 0.1, about 0.5, about 1, about 2, about 3, about 4, about 5, about 6, about 7, about 8, about 9, or about 10 g/L. In some embodiments, the concentration of dopamine or a derivative thereof in the solution of step (2) is about 0.01, about 0.05, about 0.1, about 0.5, about 1, about 2, about 3, about 4, about 5, about 6, about 7, about 8, about 9, or about 10 g/L. In some embodiments, the concentration of dopamine or a derivative thereof in the solution of step (2) is between about 1 and about 10 g/L;

In some embodiments of preparing a biosensor according to any of the embodiments above, the metallate comprises chloroplatinic acid, chloroauric acid, or chloroiridic acid. In some embodiments, the metallate comprises chloroplatinic acid. In some embodiments, the metallate comprises chloroauric acid. In some embodiments, the metallate comprises chloroiridic acid.

In some embodiments of preparing a biosensor according to any of the embodiments above, the concentration of the metallate in the solution of step (2) is between about 0.01 and about 10, between about 0.01 and about 5, between about 0.01 and about 1, between about 0.01 and about 0.5, between about 0.01 and about 0.1, between about 0.05 and about 10, between about 0.05 and about 5, between about 0.05 and about 1, between about 0.05 and about 0.5, between about 0.05 and about 0.1, between about 0.1 and about 10, between about 0.1 and about 9, between about 0.1 and about 8, between about 0.1 and about 7, between about 0.1 and about 6, between about 0.1 and about 5, between about 0.1 and about 4, between about 0.1 and about 3, between about 0.1 and about 2, between about 0.1 and about 1, between about 0.1 and about 0.5, between about 0.5 and about 10, between about 0.5 and about 9, between about 0.5 and about 8, between about 0.5 and about 7, between about 0.5 and about 6, between about 0.5 and about 5, between about 0.5 and about 4, between about 0.5 and about 3, between about 0.5 and about 2, or between about 0.5 and about 1 mg/mL. In some embodiments, the concentration of the metallate in the solution of step (2) is at least about 0.01, about 0.05, about 0.1, about 0.2, about 0.3, about 0.4, about 0.5, about 0.6, about 0.7, about 0.8, about 0.9, about 1, about 2, about 3, about 4, about 5, about 6, about 7, about 8, about 9, or about 10 mg/mL. In some embodiments, the concentration of the metallate in the solution of step (2) is less than about 0.01, about 0.05, about 0.1, about 0.2, about 0.3, about 0.4, about 0.5, about 0.6, about 0.7, about 0.8, about 0.9, about 1, about 2, about 3, about 4, about 5, about 6, about 7, about 8, about 9, or about 10 mg/mL. In some embodiments, the concentration of the metallate in the solution of step (2) is about 0.01, about 0.05, about 0.1, about 0.2, about 0.3, about 0.4, about 0.5, about 0.6, about 0.7, about 0.8, about 0.9, about 1, about 2, about 3, about 4, about 5, about 6, about 7, about 8, about 9, or about 10 mg/mL. In some embodiments, the concentration of the metallate is between about 0.1 and about 1 mg/L;

In some embodiments of preparing a biosensor according to any of the embodiments above, the pH of the solution of step (2) is between about 6 and about 10, between about 6 and about 9.5, between about 6 and about 9, between about 6 and about 8.5, between about 6 and about 8, between about 6 and about 7.5, between about 6 and about 7, between about 6 and about 6.5, between about 6.5 and about 10, between about 6.5 and about 9.5, between about 6.5 and about 9, between about 6.5 and about 8.5, between about 6.5 and about 8, between about 6.5 and about 7.5, between about 6.5 and about 7, between about 7 and about 10, between about 7 and about 9.5, between about 7 and about 9, between about 7 and about 8.5, between about 7 and about 8, between about 7 and about 7.5, between about 7.5 and about 10, between about 7.5 and about 9.5, between about 7.5 and about 9, between about 7.5 and about 8.5, between about 7.5 and about 8, between about 8 and about 10, between about 8 and about 9.5, between about 8 and about 9, between about 8 and about 8.5, between about 8.5 and about 10, between about 8.5 and about 9.5, or between about 8.5 and about 9. In some embodiments, the pH of the solution of step (2) is at least about 6, about 6.5, about 7, about 7.5, about 8, about 8.5, about 9, about 9.5, or about 10. In some embodiments, the pH of the solution of step (2) is less than about 6.5, about 7, about 7.5, about 8, about 8.5, about 9, about 9.5, or about 10. In some embodiments, the pH of the solution of step (2) is about 6, about 6.5, about 7, about 7.5, about 8, about 8.5, about 9, about 9.5, or about 10. In some embodiments, the pH of the solution of step (2) is between about 7 and about 9.

In some embodiments of preparing a biosensor according to any of the embodiments above, the dissolved oxygen concentration saturation in the solution of step (2) is less than about 10%, about 9%, about 8%, about 7%, about 6%, about 5%, about 4%, about 3%, about 2%, about 1%, about 0.5%, about 0.1%, about 0.05%, or about 0.01%. In some embodiments, the dissolved oxygen concentration saturation in the solution of step (2) is less than about 1%.

In some embodiments of preparing a biosensor according to any of the embodiments above, step (2) is conducted at a temperature of between about 10 and about 50, between about 15 and about 50, between about 20 and about 50, between about 25 and about 50, between about 30 and about 50, between about 35 and about 50, between about 40 and about 50, between about 45 and about 50, between about 10 and about 45, between about 15 and about 45, between about 20 and about 45, between about 25 and about 45, between about 30 and about 45, between about 35 and about 45, between about 40 and about 45, between about 10 and about 40, between about 15 and about 40, between about 20 and about 40, between about 25 and about 40, between about 30 and about 40, between about 35 and about 40, between about 10 and about 35, between about 15 and about 35, between about 20 and about 35, between about 25 and about 35, between about 30 and about 35, between about 10 and about 30, between about 15 and about 30, between about 20 and about 30, between about 25 and about 30, between about 10 and about 25, between about 15 and about 25, between about 20 and about 25, between about 10 and about 20, or between about 15 and about 20° C. In some embodiments, the temperature is at least about 10, about 15, about 20, about 25, about 30, about 35, about 40, or about 45° C. In some embodiments, the temperature is less than about 15, about 20, about 25, about 30, about 35, about 40, about 45, or about 50° C. In some embodiments, the temperature is about 10, about 15, about 20, about 25, about 30, about 35, about 40, about 45, or about 50° C. In some embodiments, the temperature is between about 20 and about 40° C.;

In some embodiments of preparing a biosensor according to any of the embodiments above, the potential applied to the working electrode relative to a silver/silver chloride reference solution electrode in step (2) is between about −0.5 and about 1.2, between about −0.5 and about 1, between about −0.5 and about 0.8, between about −0.5 and about 0.6, between about −0.5 and about 0.4, between about −0.5 and about 0.2, between about −0.5 and about 0, between about 0 and about 1.2, between about 0 and about 1, between about 0 and about 0.8, between about 0 and about 0.6, between about 0 and about 0.4, between about 0 and about 0.2, between about 0.2 and about 1.2, between about 0.2 and about 1, between about 0.2 and about 0.8, between about 0.2 and about 0.6, between about 0.2 and about 0.4, between about 0.4 and about 1, between about 0.4 and about 0.8, between about 0.4 and about 0.6, between about 0.6 and about 1, between about 0.6 and about 0.8, or between about 0.8 and about 1 V. In some embodiments, the potential applied to the working electrode relative to a silver/silver chloride reference solution electrode is at least about −0.5, about 0, about 0.2, about 0.4, about 0.6, about 0.8, or about 1 V. In some embodiments, the potential applied to the working electrode relative to a silver/silver chloride reference solution electrode is less than about 0, about 0.2, about 0.4, about 0.6, about 0.8, about 1, or about 1.2 V. In some embodiments, the potential applied to the working electrode relative to a silver/silver chloride reference solution electrode is about −0.5, about −0.4, about −0.2, about 0, about 0.2, about 0.4, about 0.6, about 0.8, about 1, or about 1.2 V. In some embodiments, the potential applied to the working electrode relative to a silver/silver chloride reference solution electrode is between about 0 and about 0.8 V. In some embodiments, the potential applied to the working electrode relative to a silver/silver chloride reference solution electrode is between about −0.5 and about 0.8 V.

In some embodiments of preparing a biosensor according to any of the embodiments above, the metallic nanoparticle in the solution of step (2) has a dimension as detailed herein. In some embodiments, the metallic nanoparticle has a dimension of between about 1 and about 100 nanometers.

In some embodiments of preparing a biosensor according to any of the embodiments above, the concentration of the metallic nanoparticle in the solution of step (2) is between about 500 ppm and about 8000 ppm, between about 1000 ppm and about 8000 ppm, between about 2000 ppm and about 8000 ppm, between about 3000 ppm and about 8000 ppm, between about 4000 ppm and about 8000 ppm, between about 5000 ppm and about 8000 ppm, between about 6000 ppm and about 8000 ppm, between about 7000 ppm and about 8000 ppm, between about 500 ppm and about 7000 ppm, between about 1000 ppm and about 7000 ppm, between about 2000 ppm and about 7000 ppm, between about 3000 ppm and about 7000 ppm, between about 4000 ppm and about 7000 ppm, between about 5000 ppm and about 7000 ppm, between about 6000 ppm and about 7000 ppm, between about 500 ppm and about 6000 ppm, between about 1000 ppm and about 6000 ppm, between about 2000 ppm and about 6000 ppm, between about 3000 ppm and about 6000 ppm, between about 4000 ppm and about 6000 ppm, between about 5000 ppm and about 6000 ppm, between about 500 ppm and about 5000 ppm, between about 1000 ppm and about 5000 ppm, between about 2000 ppm and about 5000 ppm, between about 3000 ppm and about 5000 ppm, between about 4000 ppm and about 5000 ppm, between about 500 ppm and about 4000 ppm, between about 1000 ppm and about 4000 ppm, between about 2000 ppm and about 4000 ppm, between about 3000 ppm and about 4000 ppm, between about 500 ppm and about 3000 ppm, between about 1000 ppm and about 3000 ppm, between about 2000 ppm and about 3000 ppm, between about 500 ppm and about 2000 ppm, between about 1000 ppm and about 2000 ppm, or between about 500 ppm and about 1000 ppm. In some embodiments, the concentration of the metallic nanoparticle in the solution of step (2) is at least about 500, about 1000, about 2000, about 3000, about 4000, about 5000, about 6000, or about 7000 ppm. In some embodiments, the concentration of the metallic nanoparticle in the solution of step (2) is less than about 1000, about 2000, about 3000, about 4000, about 5000, about 6000, about 7000, or about 8000 ppm. In some embodiments, the concentration of the metallic nanoparticle in the solution of step (2) is about 500, about 1000, about 2000, about 3000, about 4000, about 5000, about 6000, about 7000, or about 8000 ppm. In some embodiments, the concentration of the metallic nanoparticle in the solution of step (2) is between about 1000 and about 5000 ppm.

In some embodiments of preparing a biosensor according to any of the embodiments above, dopamine is used in step (2). In some embodiments, a derivative of dopamine is used in step (2). In some embodiments, the derivative of dopamine is formed by oxidizing dopamine or reducing dopamine. In some embodiments, the derivative of dopamine is formed by oxidizing dopamine. In some embodiments, the derivative of dopamine is formed by reducing dopamine. In some embodiments, the derivative of dopamine is levodopa or dihydroxyindole. In some embodiments, the derivative of dopamine is levodopa. In some embodiments, the derivative of dopamine is dihydroxyindole.

In some embodiments of preparing a biosensor according to any of the embodiments above, step (3) comprises: (a) mixing A, B, and C in an organic solvent at a temperature of between about 30 and about 45° C.; (b) adding a catalyst to the solution formed in step (a) and adding a compound comprising an isocyanate dropwise, increasing the temperature of the solution to between about 55 and about 70° C., and allowing the solution to react for between about 12 and about 20 hours at the temperature; and (c) adding deionized water to the solution formed in step (b) and allowing the resulting mixture to react for between about 12 and about 18 hours. Examples of organic solvents includes, without limitations, hexane, pentane, cyclopentane, cyclohexane, benzene, toluene, 1,4-dioxane, dichloromethane (DCM), chloroform, ethyl acetate, tetrahydrofuran (THF), cyclohexanone, dichloromethane, acetone, acetonitrile (MeCN), dimethylformamide (DMF), dimethyl sulfoxide (DMSO), 1,3-dimethyl-2-imidazolidinone (DMI), acetic acid, isobutanol, n-butanol, isopropanol, n-propanol, ethanol, and methanol and the like. In some embodiments, the organic solvent is the organic solvent is tetrahydrofuran (THF), cyclohexanone, isobutanol or a mixture thereof. In some embodiments, the organic solvent is THF. In some embodiments, the organic solvent is cyclohexanone. In some embodiments, the organic solvent is isobutanol. In some embodiments, the organic solvent is a mixture of two or three of THF, cyclohexanone, isobutanol.

In some embodiments, the ratio of the volume of the organic solvent to the total mass of A, B, and C is between about 0.1 and about 20, between about 0.1 and about 15, between about 0.1 and about 10, between about 0.1 and about 9, between about 0.1 and about 8, between about 0.1 and about 7, between about 0.1 and about 6, between about 0.1 and about 5, between about 0.1 and about 4, between about 0.1 and about 3, between about 0.1 and about 2, between about 0.1 and about 1, between about 0.1 and about 0.5, between about 1 and about 20, between about 1 and about 15, between about 1 and about 10, between about 1 and about 9, between about 1 and about 8, between about 1 and about 7, between about 1 and about 6, between about 1 and about 5, between about 1 and about 4, between about 1 and about 3, between about 1 and about 2, between about 2 and about 20, between about 2 and about 15, between about 1 and about 10, between about 2 and about 9, between about 2 and about 8, between about 2 and about 7, between about 2 and about 6, between about 2 and about 5, between about 2 and about 4, between about 2 and about 3, between about 4 and about 20, between about 4 and about 15, between about 4 and about 10, between about 4 and about 9, between about 4 and about 8, between about 4 and about 7, between about 4 and about 6, between about 4 and about 5, between about 6 and about 20, between about 6 and about 15, between about 6 and about 10, between about 6 and about 9, between about 6 and about 8, between about 6 and about 7, between about 8 and about 20, between about 8 and about 15, between about 8 and about 10, between about 8 and about 9, between about 10 and about 20, or between about 10 and about 15 mL:1 g. In some embodiments, the ratio of the volume of the organic solvent to the total mass of A, B, and C is at least about 0.1, about 0.5, about 1, about 2, about 3, about 4, about 5, about 6, about 7, about 8, about 9, about 10, or about 15 mL:1 g. In some embodiments, the ratio of the volume of the organic solvent to the total mass of A, B, and C is less than about 0.1, about 0.5, about 1, about 2, about 3, about 4, about 5, about 6, about 7, about 8, about 9, about 10, or about 15 mL:1 g. In some embodiments, the ratio of the volume of the organic solvent to the total mass of A, B, and C is about 0.1, about 0.5, about 1, about 2, about 3, about 4, about 5, about 6, about 7, about 8, about 9, about 10, or about 15 mL:1 g. 1 g. In some embodiments, the ratio of the volume of the organic solvent to the total mass of A, B, and Cis between about 2 and about 10 mL:1 g.

In some embodiments of preparing a biosensor according to any of the embodiments above, the catalyst used in step (b) comprises triethylenediamine or dibutyltin bis(2-ethylhexanoate). In some embodiments, the catalyst comprises triethylenediamine. In some embodiments, the catalyst comprises dibutyltin bis(2-ethylhexanoate). In some embodiments, the catalyst comprises a mixture of triethylenediamine and dibutyltin bis(2-ethylhexanoate).

In some embodiments of preparing a biosensor according to any of the embodiments above, the ratio of the volume of the deionized water added in step (c) to the total mass of A, B, and C is between about 0.1 and about 20, between about 0.1 and about 15, between about 0.1 and about 10, between about 0.1 and about 9, between about 0.1 and about 8, between about 0.1 and about 7, between about 0.1 and about 6, between about 0.1 and about 5, between about 0.1 and about 4, between about 0.1 and about 3, between about 0.1 and about 2, between about 0.1 and about 1, between about 0.1 and about 0.5, between about 1 and about 20, between about 1 and about 15, between about 1 and about 10, between about 1 and about 9, between about 1 and about 8, between about 1 and about 7, between about 1 and about 6, between about 1 and about 5, between about 1 and about 4, between about 1 and about 3, between about 1 and about 2, between about 2 and about 20, between about 2 and about 15, between about 1 and about 10, between about 2 and about 9, between about 2 and about 8, between about 2 and about 7, between about 2 and about 6, between about 2 and about 5, between about 2 and about 4, between about 2 and about 3, between about 4 and about 20, between about 4 and about 15, between about 4 and about 10, between about 4 and about 9, between about 4 and about 8, between about 4 and about 7, between about 4 and about 6, between about 4 and about 5, between about 6 and about 20, between about 6 and about 15, between about 6 and about 10, between about 6 and about 9, between about 6 and about 8, between about 6 and about 7, between about 8 and about 20, between about 8 and about 15, between about 8 and about 10, between about 8 and about 9, between about 10 and about 20, or between about 10 and about 15 mL:1 g. In some embodiments, the ratio of the volume of deionized water to the total mass of A, B, and C is at least about 0.1, about 0.5, about 1, about 2, about 3, about 4, about 5, about 6, about 7, about 8, about 9, about 10, or about 15 mL:1 g. In some embodiments, the ratio of the volume of deionized water to the total mass of A, B, and C is less than about 0.1, about 0.5, about 1, about 2, about 3, about 4, about 5, about 6, about 7, about 8, about 9, about 10, or about 15 mL:1 g. In some embodiments, the ratio of the volume of deionized water to the total mass of A, B, and C is about 0.1, about 0.5, about 1, about 2, about 3, about 4, about 5, about 6, about 7, about 8, about 9, about 10, or about 15 mL:1 g. 1 g. In some embodiments, the ratio of the volume of deionized water to the total mass of A, B, and C is between about 1 and about 10 mL:1 g.

In some embodiments of preparing a biosensor according to any of the embodiments above, step (3) comprises forming an adhesive layer on top of the detection layer and forming the triblock polymer on top of the adhesive layer, wherein the adhesive layer is as detailed herein. In some embodiments, the first monomer is 1,6-diaminohexane and the second monomer is glutaraldehyde. In some embodiments of preparing a biosensor according to any of the embodiments above, the process of cross-linking the first monomer and second monomer comprises: (i) applying the first monomer to the detection layer in ethanol, and (2) applying the second monomer to the detection layer in a gaseous phase at a temperature of between about 40 and about 55° C. In some embodiments, the temperature is between about 20 and about 60, between about 25 and about 60, between about 30 and about 60, between about 35 and about 60, between about 40 and about 60, between about 45 and about 60, between about 50 and about 60, between about 55 and about 60, between about 20 and about 55, between about 25 and about 55, between about 30 and about 55, between about 35 and about 55, between about 40 and about 55, between about 45 and about 55, between about 50 and about 55, between about 20 and about 50, between about 25 and about 50, between about 30 and about 50, between about 35 and about 50, between about 40 and about 50, between about 45 and about 50, between about 20 and about 45, between about 25 and about 45, between about 30 and about 45, between about 35 and about 45, between about 40 and about 45, between about 20 and about 40, between about 25 and about 40, between about 30 and about 40, between about 35 and about 40, between about 20 and about 35, between about 25 and about 35, between about 30 and about 35, between about 20 and about 30, between about 25 and about 30, or between about 20 and about 25° C. In some embodiments, the temperature is at least about 20, about 25, about 30, about 35, about 40, about 45, about 50, or about 55° C. In some embodiments, the temperature is less than about 25, about 30, about 35, about 40, about 45, about 50, about 55, or about 60° C. In some embodiments, the temperature is about 20, about 25, about 30, about 35, about 40, about 45, about 50, about 55, or about 60° C. In some embodiments, the temperature is between about 40 and about 55° C.

### EXAMPLES

The following examples are offered to illustrate but not to limit the biosensors and methods of preparation top of thereof disclosed herein.

### Example 1. Formation of Detection Layer on Electrode

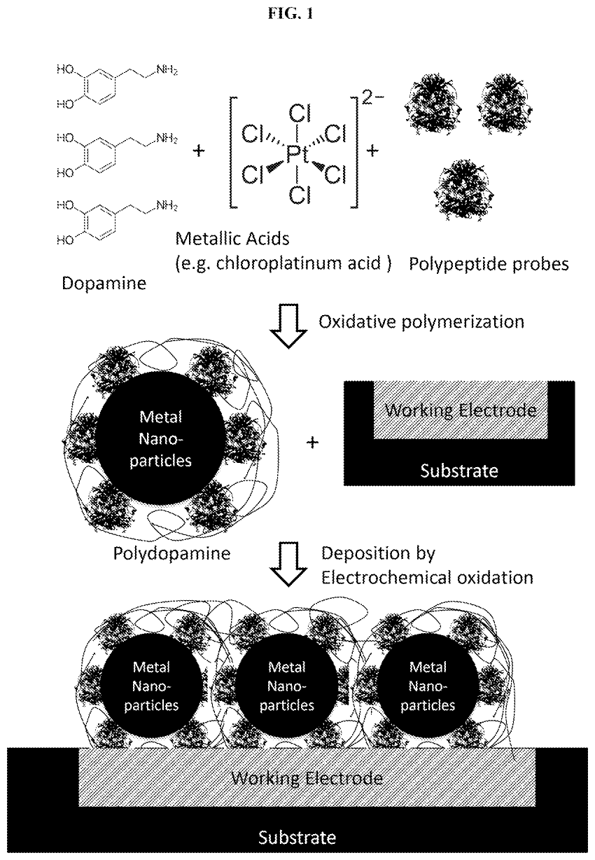

An exemplary method of forming the detection layer on top of the electrode is illustrated in FIG. 1 and detailed below.

Step 1—A platinum electrode was formed on a glass substrate via etching.

Step 2—Peptide probe molecule (glucose oxidase), dopamine, and chloroplatinic acid were added to water at 30° C. The concentrations of glucose oxidase, dopamine, and chloroplatinic acid were 5 mg/mL, 5 g/L, and 5 mg/L, respectively. The pH of the solution was adjusted to 8 and the dissolved oxygen concentration saturation in the solution was less than 1%. Metallic nanoparticles with a coating containing polydopamine and the peptide probe were thereby formed in the solution.

Step 3—The platinum electrode prepared in step 1 was placed into the solution of step 2 and the metallic nanoparticles formed in step 2 were deposited on top of the electrode via an electrochemical oxidation reaction. The potential applied to the electrode relative to a silver/silver chloride reference solution electrode was 0.4 V.

### Example 2. Formation of Detection Layer on Electrode

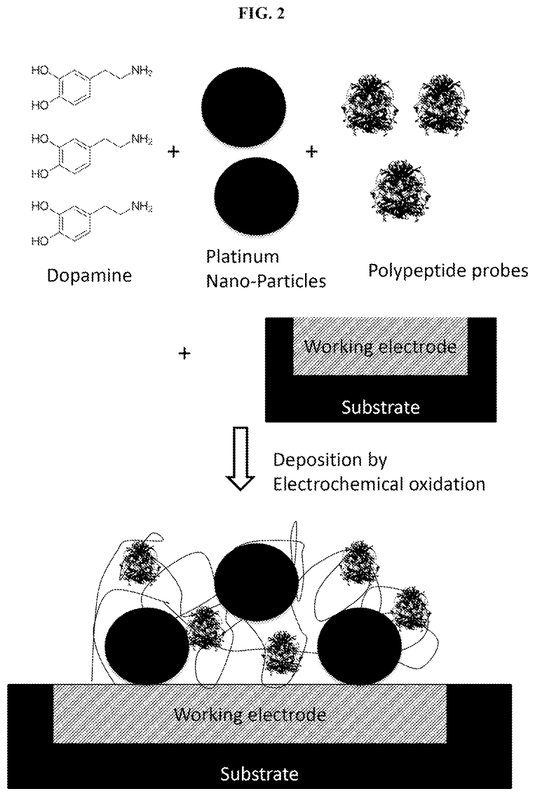

Another exemplary method of forming the detection layer on top of the electrode is illustrated in FIG. 2 and detailed below.

Step 1—A gold electrode was formed on a polydimethylsiloxane substrate via screen printing.

Step 2—Gold nanoparticle, peptide probe molecule (hepatitis B antibody), and dopamine were added to water at 35° C. The size of the gold nanoparticle was about 50 nanometers. The concentrations of the gold nanoparticle, peptide probe molecule, and dopamine were 25000 ppm, 4 mg/mL, and 6 g/L, respectively. The pH of the solution was adjusted to 7 and the dissolved oxygen concentration saturation in the solution was less than 1%. The gold electrode prepared in step 1 was immersed in the solution. A detection layer containing polydopamine, gold nanoparticle, and peptide probe was formed on top of the electrode via an electrochemical oxidation reaction. The potential applied to the electrode relative to a silver/silver chloride reference solution electrode was 0.6 V.

### Example 3. Formation of Biocompatible Membrane

### i. Example 3.1

Step 1—Polyetheramine (number average molecular weight: 1000; 25 g), polycarbonate diol (number average molecular weight: 5000; 10 g), diamino-terminated polydimethylsiloxane (number average molecular weight: 5000; 15 g) were added to 100 mL of tetrahydrofuran at 40° C. and mixed well.

Step 2—To the solution of step 1 was added triethylenediamine. 12 g methylene diphenyl diisocyanate was then added dropwise. The mixture was reacted at 65° C. for 12 h.

Step 3—To the solution of step 2 was added 50 mL deionized water and the mixture was reacted for 12 h.

The resulting triblock polymer was applied to the detection layer formed in Example 1 or 2 using suitable methods.

### ii. Example 3.2

Step 1—Amino-terminated polyethylene glycol (number average molecular weight: 2000; 20 g), polycarbonate diol (number average molecular weight: 2000; 15 g), poly (methyl methacrylate) (number average molecular weight: 2000; 15 g), and diamino-terminated polydimethylsiloxane (number average molecular weight: 8000; 15 g) were added to 500 mL of tetrahydrofuran at 30° C. and mixed well.

Step 2—To the solution of step 1 was added triethylenediamine. A mixture of methylene diphenyl diisocyanate and bis(4-isocyanatocyclohexyl)methane was then added dropwise. The mixture was reacted at 55° C. for 14 h.

Step 3—To the solution of step 2 was added 500 mL deionized water and the mixture was reacted for 18 h.

The resulting triblock polymer was applied to the detection layer formed in Example 1 or 2 using suitable methods.

### iii. Example 3.3

Step 1—Amino-terminated polypropylene glycol (molecular weight: 500; 15 g), polyetheramine (molecular weight: 600; 10 g), poly(bisphenol A polycarbonate) (molecular weight: 5000; 25 g), diamino-terminated polydimethylsiloxane (molecular weight: 20000; 10 g), poly(2-hydroxyethyl methacrylate) (molecular weight: 5000; 5 g) were added to 150 mL isobutanol at 35° C. and mixed well.

Step 2—To the solution of step 1 was added dibutyltin bis(2-ethylhexanoate). 15 g hexamethylene diisocyanate was then added dropwise. The mixture was reacted at 60° C. for 16 h.

Step 3—To the solution of step 2 was added 150 mL deionized water and the mixture was reacted for 14 h.

The resulting triblock polymer was applied to the detection layer formed in Example 1 or 2 using suitable methods.

### iv. Example 3.4

Step 1—Amino-terminated polyethylene glycol (number average molecular weight: 10000; 30 g), polycarbonate diol (number average molecular weight: 2000; 5 g), poly (methyl methacrylate) (number average molecular weight: 2000; 5 g), and poly(2-hydroxyethyl methacrylate) (molecular weight: 20000; 15 g) were added to 600 mL isobutanol at 35° C. and mixed well.

Step 2—To the solution of step 1 was added dibutyltin bis(2-ethylhexanoate). 20 g bis(4-isocyanatocyclohexyl)methane was then added dropwise. The mixture was reacted at 70° C. for 16 h.

The resulting triblock polymer was applied to the detection layer formed in Example 1 or 2 using suitable methods.

### Example 4. Formation of Adhesive Layer

Step 1—10 g 1,6-diaminohexane was dissolved in 100 mL ethanol.

Step 2—The substrate with a detection layer formed in Example 1 or 2 was immersed in the solution of step 1 for 10 minutes, rinsed three times with ethanol, immersed in ethanol for 10 minutes, and dried.

Step 3—The substrate prepared in step 2 was exposed to glutaraldehyde in gas phase at 40° C. for 10 minutes.

Step 4—The solution formed in any one of Examples 3.1-3.4 was applied to the substrate prepared in step 3 and a biocompatible membrane was formed via spin coating.

### Example 5

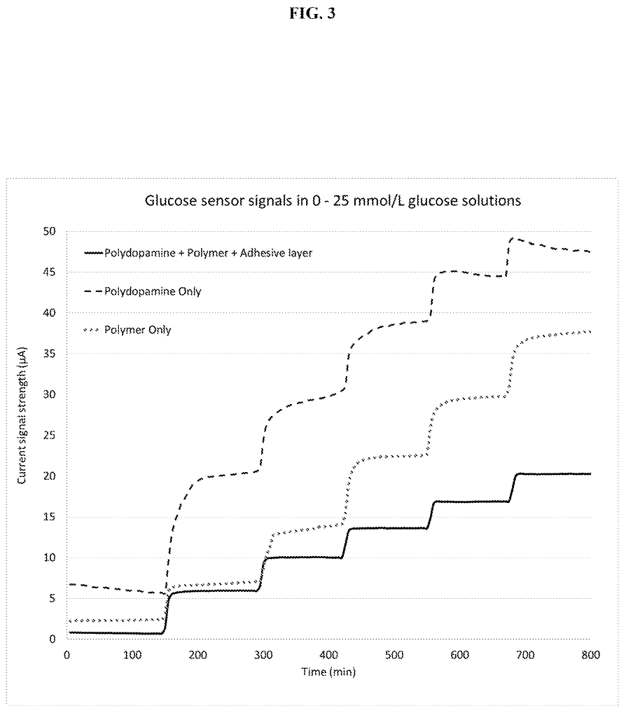

A biosensor that only has the detection layer as described herein, a biosensor that only has the biocompatible membrane and detection probe layer deposited by conventional methods as described herein, and a biosensor that has the detection layer, the biocompatible membrane, and the adhesive layer as described herein were exposed to a glucose solution. For each biosensor, a constant potential was applied to the working electrode and the current output on the working electrode was measured at six glucose concentrations: 0 mmol/L, 5 mmol/L, 10 mmol/L, 15 mmol/L, 20 mmol/L, and 25 mmol/L. FIG. 3 shows the current output over time at different glucose concentrations for each biosensor. As shown in FIG. 3, the biosensor that has the detection layer, the biocompatible membrane, and the adhesive layer as described herein showed more stable current output over time and better linearity in response to increase in glucose concentration.

While the foregoing description of the biosensors and methods described herein enables one of ordinary skill to make and use the biosensors and methods described herein, those of ordinary skill will understand and appreciate the existence of variations, combinations, and equivalents of the specific embodiment, method, and examples herein. The biosensors and methods provided herein should therefore not be limited by the above-described embodiments, methods, or examples, but rather encompasses all embodiments and methods within the scope and spirit of the compounds, uses, and methods provided herein.

What is claimed is:

1. A biosensor, comprising:
a substrate;
a working electrode on top of the substrate;
a detection layer on top of the working electrode, wherein the detection layer comprises a metallic nanoparticle, polydopamine, and a peptide probe;
a biocompatible membrane on top of the detection layer, wherein the biocompatible membrane comprises a triblock polymer A-b-B-b-C, wherein:
A is a hydrophilic soft segment,
B is a hydrophobic hard segment,
C is a flexible polymer segment, and
b is a chain extender.

2. The biosensor of claim 1, wherein the working electrode comprises carbon, graphene, gold, or platinum.

3. The biosensor of claim 1, wherein the metallic nanoparticle is a platinum nanoparticle, a gold nanoparticle, or an iridium nanoparticle.

4. The biosensor of claim 1, wherein the metallic nanoparticle has a dimension of between 1 nanometer and 100 nanometers.

5. The biosensor of claim 1, wherein the peptide probe comprises an enzyme, an antibody, or a polymer comprising a peptide.

6. The biosensor of claim 1, wherein the peptide probe comprises an oxidoreductase.

7. The biosensor of claim 1, wherein the peptide probe comprises glucose oxidase, glucose dehydrogenase, or horseradish peroxidase.

8. The biosensor of claim 1, wherein the metallic nanoparticle is coated with polydopamine and the peptide probe.

9. The biosensor of claim 1, wherein the metallic nanoparticle is admixed with polydopamine and the peptide probe.

10. The biosensor of claim 1, wherein the hydrophilic soft segment comprises a polymer selected from the group consisting of polyethylene glycol (PEG), polypropylene glycol (PPG), and polyetheramine (PEA).

11. The biosensor of claim 1, wherein the hydrophobic hard segment comprises a polymer selected from the group consisting of polycarbonate (PC) and poly(methyl methacrylate) (PMMA).

12. The biosensor of claim 1, wherein the flexible polymer segment comprises a polymer selected from the group consisting of polydimethylsiloxane (PDMS) and poly(2-hydroxyethyl methacrylate) (PHEMA).

13. The biosensor of claim 1, wherein the chain extender in the biocompatible membrane is derived from a compound comprising an isocyanate.

14. The biosensor of claim 1, wherein each chain extender is independently derived from methylene diphenyl diisocyanate (MDI), hexamethylene diisocyanate (HDI), or bis(4-isocyanatocyclohexyl)methane.

15. The biosensor of claim 1, wherein:
a number average molecular weight of A is between 200 and 10000,
a number average molecular weight of B is between 1000 and 20000, and
a number average molecular weight of C is between 1000 and 20000.

16. The biosensor of claim 1, wherein the biocompatible membrane comprises:
between 1 and 10 parts by weight of A,
between 1 and 5 parts by weight of B,
between 1 and 5 parts by weight of C, and
between 1 and 3 parts by weight of b.

17. The biosensor of claim 1, wherein a linkage between each of A-b, B-b, and C-b is independently a urea linkage or a carbamate linkage.

18. The biosensor of claim 1, wherein the biosensor further comprises an adhesive layer between the detection layer and the biocompatible membrane, wherein the adhesive layer comprises a polymer comprising a first monomer comprising at least two amine moieties crosslinked with a second monomer comprising at least two formyl moieties.

19. The biosensor of claim 18, wherein the first monomer is 1,6-diaminohexane and the second monomer is glutaraldehyde.

20. The biosensor of claim 1, further comprising a blank electrode, wherein the blank electrode is substantially same as the working electrode, a counter electrode, and a reference electrode, wherein the blank electrode is directly covered by the biocompatible membrane.

21. The biosensor of claim 18, further comprising a blank electrode wherein the blank electrode is substantially same as the working electrode, a counter electrode, and a reference electrode, wherein the blank electrode is directly covered by the adhesive layer, wherein the adhesive layer is covered by the biocompatible membrane.

22. The biosensor of claim 20, wherein a minimum distance between the working electrode and the blank electrode is no more than 5 mm.

23. A method of preparing a biosensor, comprising:
(1) forming a working electrode on a substrate;
(2) forming a detection layer on top of the working electrode, wherein the detection layer comprises a metallic nanoparticle, polydopamine, and a peptide probe;
(3) forming a triblock polymer A-b-B-b-C on top of the detection layer, wherein:
A is a hydrophilic soft segment,
B is a hydrophobic hard segment,
C is a flexible polymer segment, and
b is a chain extender.

24. The method of claim 23, wherein the working electrode comprises carbon, graphene, gold, or platinum.

25. The method of claim 23, wherein step (1) comprises forming the working electrode on top of the substrate by etching or screen printing.

26. The method of claim 23, wherein the metallic nanoparticle is a platinum nanoparticle, a gold nanoparticle, or an iridium nanoparticle.

27. The method of claim 23, wherein the metallic nanoparticle has a dimension of between 1 nanometer and 100 nanometers.

28. The method of claim 23, wherein the peptide probe comprises an enzyme, an antibody, or a polymer comprising a peptide.

29. The method of claim 23, wherein the peptide probe comprises an oxidoreductase.

30. The method of claim 23, wherein the peptide probe comprises glucose oxidase, glucose dehydrogenase, or horseradish peroxidase.

31. The method of claim 23, wherein the hydrophilic soft segment comprises a polymer selected from the group consisting of polyethylene glycol (PEG), polypropylene glycol (PPG), and polyetheramine (PEA).

32. The method of claim 23, wherein the hydrophobic hard segment comprises a polymer selected from the group consisting of polycarbonate (PC) and poly(methyl methacrylate) (PMMA).

33. The method of claim 23, wherein the flexible polymer segment comprises a polymer selected from the group consisting of polydimethylsiloxane (PDMS) and poly(2-hydroxyethyl methacrylate) (PHEMA).

34. The method of claim 23, wherein the chain extender in the biocompatible membrane is derived from a compound comprising an isocyanate.

35. The method of claim 23, wherein each chain extender is independently derived from methylene diphenyl diisocyanate (MDI), hexamethylene diisocyanate (HDI), or bis(4-isocyanatocyclohexyl)methane.

36. The method of claim 23, wherein:
a number average molecular weight of A is between 200 and 10000,
a number average molecular weight of B is between 1000 and 20000, and
a number average molecular weight of C is between 1000 and 20000.

37. The method of claim 23, wherein the biocompatible membrane comprises:
between 1 and 10 parts by weight of A,
between 1 and 5 parts by weight of B,
between 1 and 5 parts by weight of C, and
between 1 and 3 parts by weight of b.

38. The method of claim 23, wherein a linkage between each of A-b, B-b, and C-b is independently a urea linkage or a carbamate linkage.

39. The method of claim 23, wherein step (2) comprises:
(a) mixing the peptide probe, dopamine or a derivative of dopamine, and a metallate in water, thereby forming a solution comprising a metallic nanoparticle with a coating comprising polydopamine and the peptide probe, wherein the metallate is an oxidizing agent; and
(b) depositing the metallic nanoparticle with the coating comprising polydopamine and the peptide probe on top of the working electrode by an electrochemical oxidation reaction.

40. The method of claim 39, wherein:
(i) a concentration of the peptide probe in the solution is between 0.1 mg/mL and 10 mg/mL;
(ii) a concentration of dopamine or the derivative of dopamine in the solution is between 1 g/L and 10 g/L;
(iii) the metallate comprises chloroplatinic acid, chloroauric acid, or chloroiridic acid, wherein a concentration of the metallate is between 0.1 mg/L and 1 mg/L;
(iv) a pH of the solution is between 7 and 9;
(v) a dissolved oxygen concentration saturation in the solution is less than 1%;
(vi) a temperature is between 20° C. and 40° C.; and/or
(vii) a potential applied to the working electrode relative to a silver/silver chloride reference solution electrode is between 0 V and 0.8 V.

41. The method of claim 23, wherein step (2) comprises:
(a) mixing the metallic nanoparticle, the peptide probe, and dopamine or the derivative of dopamine in water;
(b) contacting the working electrode with the solution formed in step (a); and
(c) forming the detection layer on top of the working electrode by an electrochemical oxidation reaction.

42. The method of claim 41, wherein:
(i) the metallic nanoparticle has a dimension of between 1 nanometer and 100 nanometers;
(ii) a concentration of the metallic nanoparticle is between 1000 ppm and 5000 ppm;
(iii) the concentration of the peptide probe in the solution is between 0.1 mg/mL and 10 mg/mL;
(iv) the concentration of dopamine or the derivative of dopamine in the solution is between 1 g/L and 10 g/L;
(v) the pH of the solution is between 7 and 9;
(vi) the dissolved oxygen concentration saturation in the solution is less than 1%;
(vii) the temperature is between 20° C. and 40° C.; and/or
(viii) the potential applied to the working electrode relative to a silver/silver chloride reference solution electrode is between −0.5 V and 0.8 V.

43. The method of claim 23, wherein dopamine is used in step (2).

44. The method of claim 23, wherein the derivative of dopamine is used in step (2), wherein the derivative of dopamine is formed by oxidizing dopamine or reducing dopamine.

45. The method of claim 44, wherein the derivative of dopamine is levodopa or dihydroxyindole.

46. The method of claim 23, wherein step (3) comprises:
(a) mixing A, B, and C in an organic solvent at a temperature of between 30° C. and 45° C.;
(b) adding a catalyst to a solution formed in step (a) and adding a compound comprising an isocyanate dropwise, increasing the temperature of the solution to between 55° C. and 70° C., and allowing the solution to react for between 12 hours and 20 hours at the temperature; and
(c) adding a deionized water to the solution formed in step (b) and allowing a resulting mixture to react for between 12 hours and 18 hours.

47. The method of claim 46, wherein:
(i) the organic solvent is tetrahydrofuran (THF), cyclohexanone, isobutanol or a mixture of isobutanol; and
(ii) a ratio of a volume of the organic solvent to a total mass of A, B, and C is between 2 mL:1 g and 10 mL:1 g.

48. The method of claim 46, wherein the catalyst comprises triethylenediamine or dibutyltin bis(2-ethylhexanoate).

49. The method of claim 46, wherein a ratio of a volume of the deionized water added in step (c) to the total mass of A, B, and C is between 1 mL:1 g and 10 mL:1 g.

50. The method of claim 23, wherein step (3) comprises forming an adhesive layer on top of the detection layer and forming the triblock polymer on top of the adhesive layer, wherein the adhesive layer comprises a polymer comprising a first monomer comprising at least two amine moieties crosslinked with a second monomer comprising at least two formyl moieties.

51. The method of claim 50, wherein the first monomer is 1,6-diaminohexane and the second monomer is glutaraldehyde.

52. The method of claim 50, comprising:
(i) applying the first monomer to the substrate in ethanol, and
(2) applying the second monomer to the substrate in a gaseous phase at a temperature of between 40° C. and 55° C.
